(19) United States
(12) Patent Application Publication
(10) Pub. No.: US 2020/0090130 A1
(43) Pub. Date: Mar. 19, 2020

(54) SYSTEM AND METHOD FOR CUSTOM CALENDARING

(71) Applicant: ServiceNow, Inc., Santa Clara, CA (US)

(72) Inventors: Marta Penzo, Amsterdam (NL); Jagadeesan Babu, Amsterdam (NL); Adrianus Augustinus Mathijssen, Amsterdam (NL); Petrus Goris, Amsterdam (NL); Cheng Di, Amsterdam (NL); Isaak Papagiannidis, Amsterdam (NL); Aida Rikovic Tabak, Amsterdam (NL)

(21) Appl. No.: 16/133,450

(22) Filed: Sep. 17, 2018

(51) Int. Cl. G06Q 10/10; G06F 17/24; G06F 17/30

(52) U.S. Cl. CPC G06Q 10/109; G06F 17/30604; G06F 17/245

(57) ABSTRACT

A computing system includes a server. The server is communicatively coupled to a data repository clone and is configured to store a calendar-based data in the data repository. The server is further configured to receive a request to create a custom calendar, and to create the custom calendar based on a calendar data schema and the request. The server is additionally configured to provide the custom calendar to systems communicatively coupled to the server. The server is also configured to provide a data analysis using the calendar-based data and the custom calendar.

### BACKGROUND

The present disclosure relates generally to calendaring and, more particularly, to custom calendaring.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

Within the context of cloud computing solutions for data repositories, users may be asked to deal with ever increasing amounts of data, e.g., including certain date-based information stored in the data repositories. In fact, the amount of cloud-based and date-based data collected and stored in today's cloud computing solutions, such as cloud-based repositories, may be orders of magnitude greater than what was historically collected and stored. Users tasked with automating and/or troubleshooting enterprise, IT, and/or other organization-related functions (e.g., incident tracking and/or help desk-related functions) navigate ever increasing amounts of date-based data to properly and efficiently perform their job functions. In certain embodiments, cloned data repositories may be created. With this in mind, the following embodiments are directed to improving the manner in which date-based data may be custom calendared for certain data repositories, including cloned data repositories.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Information Technology (IT) networks may include a number of computing devices, server systems, databases, and the like that generate, collect, and store information. As increasing amounts of data representing vast resources become available, it becomes increasingly difficult to analyze the data, interact with the data, and/or provide reports for the data. The current embodiments enable customized systems and methods to transform such data into calendared information, including the creation of custom calendars. Anonymized clones of various databases, including cloud-based databases, may each create and/or include one or more custom calendars suitable for providing information in a context specific to certain applications. For example, fiscal calendar-based applications, manufacturing calendar-based applications, academic calendar-based applications, sales-based applications, farming-based applications, and so on. More specifically, the techniques described herein may include data transformations that transform the date-based information in a cloned (or non-cloned) data repository into information that may be presented and processed as calendared information part of one or more calendars. In some embodiments, the calendars may be custom calendars, as further described below.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a block diagram of a computing device utilized in the distributed computing system of FIG. 1, in accordance with an embodiment;

FIG. 3 is a block diagram of an embodiment of a computing device utilized in a computing system that may be present in FIG. 1 or 2, in accordance with aspects of the present disclosure;

FIG. 4 is a block diagram illustrating a custom calendaring system suitable for creating custom calendars, in accordance with an embodiment;

FIG. 5 is an entity-relationship diagram illustrating a calendaring schema, in accordance with an embodiment;

FIG. 6 is a screenshot of an embodiment of a graphical user interface (GUI) suitable for inputting certain calendar configuration information for various custom calendars;

FIG. 7 is a screenshot of an embodiment of a GUI suitable for the retrieval of the various fiscal periods associated with a custom calendar;

FIG. 8 is a screenshot depicting an embodiment of a GUI that may be used to select and then to analyze certain calendar-based data;

FIG. 9 is a screenshot illustrating an embodiment of a GUI that may be displaying results from querying certain calendar-based data or records and mapping the results as belonging to custom calendar periods; and

FIG. 10 is a flowchart of an embodiment of a process suitable for creating one or more custom calendars and for providing for data entry, data analysis and/or data management via the custom calendars.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device that includes, but is not limited to a computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. As used herein, the term “date-based information” may refer to data that includes or may be linked to information that may identify the date-based information, such as a datetime record (e.g., timestamp) that may include a time (e.g., microseconds, seconds, minutes, hours), a day (e.g., Gregorian calendar day), a week, and month, a year, an operating system (OS) timestamp (e.g., POSIX time, Unix time), and Epoch time (e.g., time elapsed since a certain event), or a combination thereof. Custom calendar as described herein may refer to a calendar having periods which may be customized to a desired time length, such as a semester having four months, a manufacturing run having two months, etc. In some cases the periods may repeat, such as weeks having seven days and then repeating. The custom calendar may also have a start and an end date. Each period may include the same length or different lengths. For example, a first manufacturing run may include two months while a second manufacturing run may include one month. Periods may include days, weeks, quarters (e.g., fiscal quarters), months, years, and so on.

Present embodiments are directed to creating one or more calendars, including custom calendars, in data repository clones or instances from a data repository. More specifically, the techniques described herein may include data transformations that may be used to create a custom calendar based on data stored in a different calendar type (e.g., Gregorian calendar) or instance. The techniques described herein may include one or more database schemas suitable for storing custom calendar data, as well as for transforming data from a first calendar into a second calendar, as further described below. Accordingly, queries, data analysis, models, and so forth, may be stored on or for a first calendar type (e.g., Gregorian calendar and may be translated for a second calendar type (e.g., fiscal calendar) thus providing for improved data analysis in calendar formats used by various entities (e.g., academic entities, business entities, farming entities, manufacturing entities, and so on).

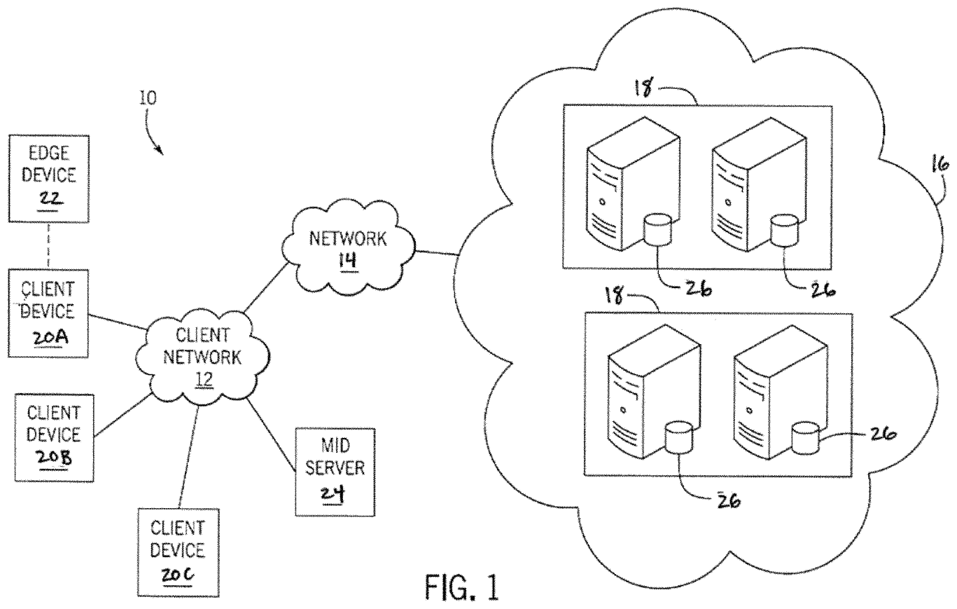

With the preceding in mind, the following figures relate to various types of generalized system architectures or configurations that may be employed to provide services to an organization accessing a cloud-platform, such as may be embodied in a multi-instance or multi-tenant framework on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 in which embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) that includes a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, in order to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), WiFi® networks (WIFI is a registered trademark owned by Wi-Fi Alliance Corporation), and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary Java® Virtual Machine), and/or a database server, e.g., a unitary MySQL® catalog (MySQL® is a registered trademark owned by MySQL AB A COMPANY).

The virtual servers 26 may store or access a variety of data, including data that may have date-based information. For example, manufacturing data, financial data, farming data, company operations data, accounting data, and so on, may be include date-based information specifying one or more points in time associated with the data. Indeed, dates of manufacture, dates of sale, dates of incidents, expiration dates, scheduled dates, and so on, may be stored in the virtual servers 26. The virtual servers 26 may then use the techniques described herein to provide for one or more calendars for data having-based information, including custom calendars.

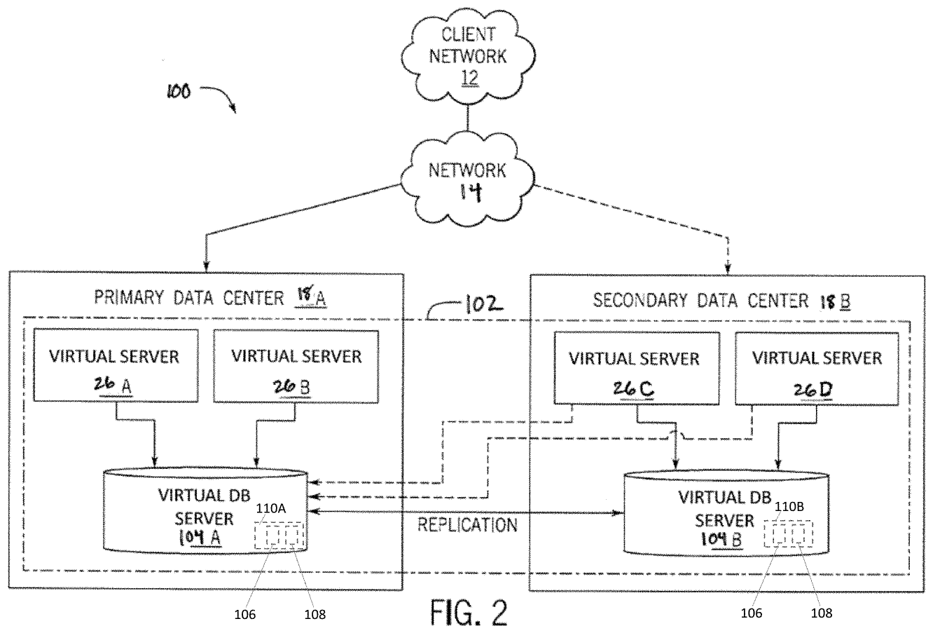

To utilize computing resources within the platform 16, network operators may choose to configure the data centers 18 using a variety of computing infrastructures. In one embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 40 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a simply client instance 102) is associated with (e.g., supported and enabled by) dedicated virtual servers 26 (e.g., virtual servers 26A, 26B, 26C, and 26D) and dedicated database servers (e.g., virtual database servers 104A and 104B). Stated another way, the virtual servers 26A, 26B, 26C, 26D and virtual database servers 104A, 104B are not shared with other client instances but are specific to the respective client instance 102. Other embodiments of the multi-instance cloud architecture 100 could include other types of dedicated virtual servers, such as a web server. For example, the client instance 102 could be associated with (e.g., supported and enabled by) the dedicated virtual servers 26A, 26B, 26C, 26D, dedicated virtual database servers 104A, 104B, and additional dedicated virtual web servers (not shown in FIG. 2).

In the depicted example, to facilitate availability of the client instance 102, the virtual servers 26A, 26B, 26C, 26D and virtual database servers 104A, 104B are allocated to two different data centers 18A, 18B, where one of the data centers 18 acts as a backup data center 18. In reference to FIG. 2, data center 18A acts as a primary data center 18A that includes a primary pair of virtual servers 26A, 26B and the primary virtual database server 104A associated with the client instance 102, and data center 18B acts as a secondary data center 18B to back up the primary data center 18A for the client instance 102. To back up the primary data center 18A for the client instance 102, the secondary data center 18B includes a secondary pair of virtual servers 26C, 26D and a secondary virtual database server 104B. The primary virtual database server 104A is able to replicate data to the secondary virtual database server 104B.

As shown in FIG. 2, the primary virtual database server 104A may replicate data to the secondary virtual database server 104B using, e.g., a Master-Master MySQL Binlog replication operation. The replication of data between data could be implemented by performing full backups weekly and daily incremental backups in both data centers 18A, 18B. Having both a primary data center 18A and secondary data center 18B allows data traffic that typically travels to the primary data center 18A for the client instance 102 to be diverted to the second data center 18B during a failure and/or maintenance scenario. Using FIG. 2 as an example, if the virtual servers 26A, 26B and/or primary virtual database server 104A fails and/or is under maintenance, data traffic for client instances 102 can be diverted to the secondary virtual servers 26C, 26D and the secondary virtual database server instance 104B for processing.

In the depicted embodiment, a database server, such as the servers 104A and/or 104B, may include calendar-based data 106, 108, having date-based information. That is, the calendar-based data 106 may be a data set that may be associated with a first type of calendar (e.g., Gregorian calendar), while calendar-based data 108 may be a data set associated with a second type of calendar different than the first type (e.g., fiscal calendar, academic calendar, manufacturing calendar, sales calendar, farming calendar). The techniques described herein may allow the creation of custom calendars for the calendar-based data 106 and/or 108, as well as for the transformation of data from a first calendar-based data 106 to a second calendar-based data 108, or vice versa. That is, in addition to the creation of data in the first or second calendar type, the techniques described herein may additionally transform data from one calendar type into data in a different calendar type. The transformation of data from one type of calendar to a second type of calendar may include providing tables, views (e.g., SQL views), creating new rows, creating new columns, creating new tables, and so on.

In certain embodiments, a custom calendaring system 110 is provided. The custom calendaring system 110 may include application programming interfaces (APIs), tables, views, queries, schemas, and so on, suitable for creating, updating, and/or transforming calendar-based data, such as the calendar-based data 106, 108. It is also to be noted that while two types of calendar-based data 106 and 108 are shown, the techniques described herein may provide for the creation, update, and/or transformation of any number of calendar data types (e.g., fiscal, manufacturing, academic, farming, Gregorian, Epoch-based, and so on). Accordingly, users of the system 10, including software applications, may more easily process, analyze, and visualize data in a variety of calendar formats, including calendar-based data 106, 108.

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server. Using FIG. 2 as an example, the virtual servers 26A, 26B, 26C, 26D and virtual database servers 104A, 104B may be combined into a single virtual server. The use and discussion of FIGS. 1 and 2 are only examples to facilitate ease of description and explanation of discrete or functional concepts and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

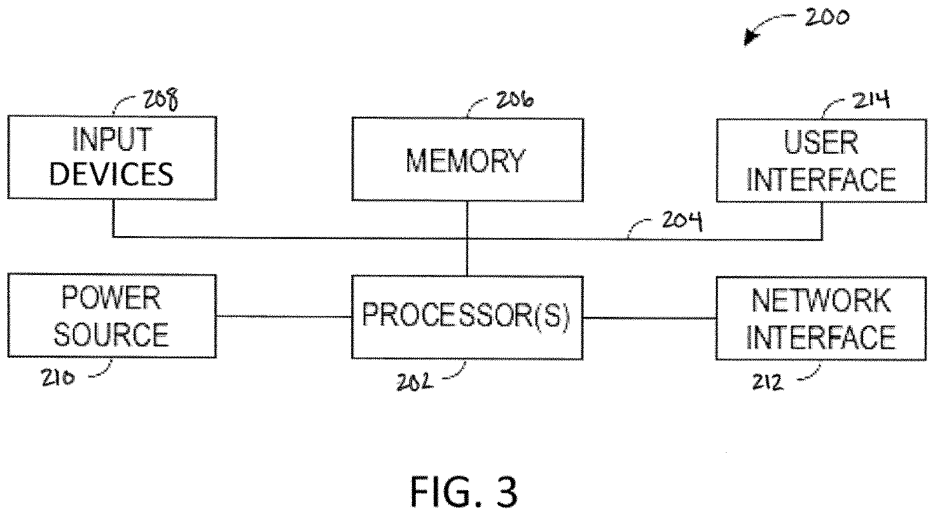

With this in mind, and by way of background, it may be appreciated that the present approach may be implemented using one or more processor-based systems such as shown in FIG. 3. Likewise, applications and/or databases utilized in the present approach stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 includes suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processor 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

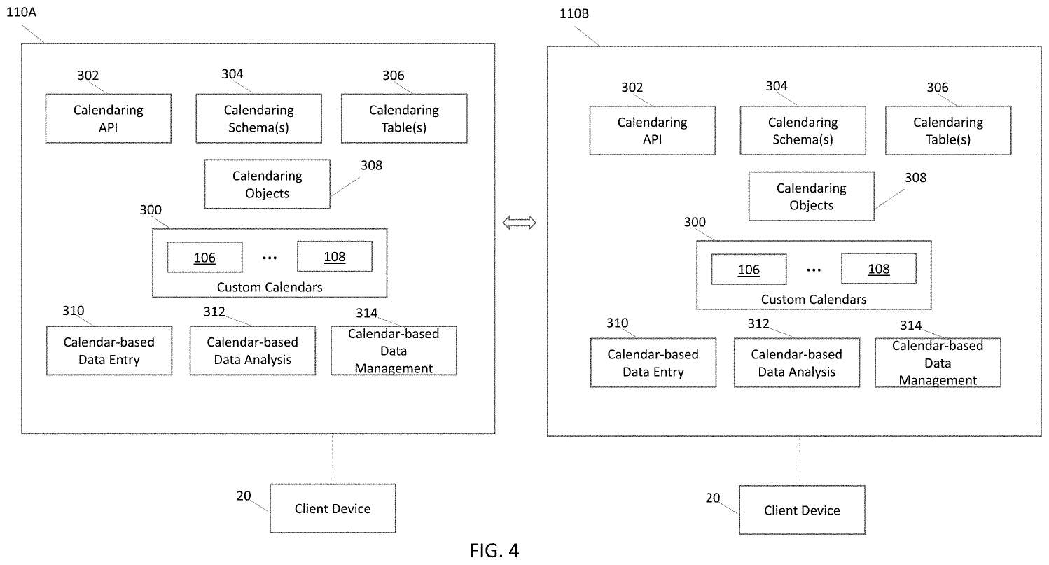

Turning now to FIG. 4, the figure is a block diagram illustrating an embodiment of the custom calendaring system 110A suitable for creating custom calendars 300. It is to be understood that the custom calendaring system 110A depicted is an example only and may be included in or implemented using one or more of the virtual servers 26, the virtual DB servers 104, or a combination thereof. In the depicted embodiment, the custom calendaring system 110A includes a set of calendaring application programming interfaces (APIs) 302. The calendaring APIs 302 may include executable code or computer instructions suitable for creating, managing, accessing, updating and/or deleting the custom calendars 300. The calendaring APIs 302 may thus include classes, methods, functions, data structures, and so on, callable by a client application of the one or more of the virtual servers 26 and/or the virtual DB servers 104. The calendaring APIs 302 may be written in a variety of languages such as JavaScript, Java, C, C#, SQL, Visual Basic, and the like.

Calendaring schema(s) 304 may be used to define one or more of the custom calendars 300. For example, the calendaring schemas 304 may define a set of entities (e.g., tables) and relationships between entities suitable for capturing various calendar types (e.g., fiscal, manufacturing, academic, farming, Gregorian, Epoch-based, and so on). That is, the calendaring schema(s) 304 may be used to define calendar start dates, end dates, repeating periods (e.g., in seconds, minutes, hours, days, weeks, months, years, or combinations thereof), non-repeating periods, schedule periods (e.g., periods when events are triggered automatically via a server, such as the sending of a survey), times or dates for certain events (e.g., manufacturing events, fiscal events, academic events, farming events, sales events), and so on.

The calendaring schema(s) 304 may be implemented as a set of calendaring table(s) 306 and/or calendaring objects 308. For example, entities in the calendaring schema(s) 304 may be used to create a set of tables and relationships between tables (e.g., relational database relationships). Likewise entities in the calendaring schema(s) 304 may be used to create one or more calendaring objects 308 (e.g., JavaScript objects). The calendaring objects 308 may be suitable for creating custom calendars 300, updating the custom calendars 300, deleting the custom calendars 300, and so on. Accordingly, the client devices 20 may be communicatively coupled to the custom calendaring system 110A and execute various types of custom calendar-based data entry 310, calendar-based data analysis 312, calendar-based data management 314, and so on.

As mentioned earlier, multiple clones or instances may be created by the techniques described herein. Accordingly, also illustrated is a clone 110B that may include cloned calendar-based data 106, 108. The instances 110A, 110B may be kept in synch with each other via push-pull techniques, master-slave techniques, data mirroring techniques, data publication/subscription techniques, and so on.

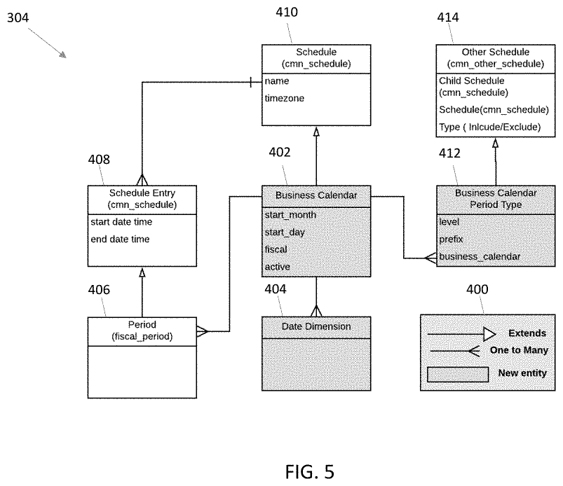

FIG. 5 depicts an embodiment of one of the calendaring schemas 304 suitable for creating, updating, and managing a custom calendar, such as a fiscal year based calendar. For example, calendar-based data 106 may be stored in a first calendar type (e.g., Gregorian calendar) and by using the calendaring schema 304 the calendar-based data 106 may be transformed into calendar-based data 108 stored in a different calendar type (e.g., fiscal calendar). It is to be understood that the schema 304 may be used or modified for other calendar types, (e.g., academic calendars, sales calendars, fiscal calendars, farming calendars, and so on).

A legend 400 for the calendaring schema 304 is also provided. In the depicted embodiment a business calendar entity 402 may capture a start day, start month, fiscal type, and active or inactive calendar. Each business calendar entity 400 may have one or more date dimension entities 404. For example, one record per day (or week, or any other time period) may be stored in the date dimension entity 404. The date dimension entity 404 may be used to map from a first calendar type into a second calendar type. For example, for a given timestamp such as a Gregorian day (e.g. DateTime) the date dimension entity 404 may then include several columns that map the Gregorian day into various calendar dimensions or “slots” in a second calendar type, such as quarter (e.g., 4 quarters), weeks (e.g., 52 weeks), fiscal year, and so on.

By using the date dimension entity 404 each day may be stored without risks of gaps. It may also be easier to store public holidays and special events. The fields are not calculated but stored in a table to be retrieved when desired. Accordingly, certain calculation time may be alleviated. The ability to easily query such things as “All the last day of the quarter”, “Last number of Mondays for this period”, and so on, may be provided.

For example only, a list of columns of the date dimension entity 404 associated with a given Gregorian day (e.g., 365 days for a non-leap year) may include: Date Full (Date) as a Gregorian Date time type and columns used to map, including but not limited to: Day Num of Month, Day Num of Quarter, Day Num of Week, Day Num of Year, Day of Week Abbreviation (ABBR), Day of Week Name, Day of Week Surf, Linear Day of Month, Linear Week of Quarter, Linear Week of Quarter Begin Date, Linear Week of Quarter End Date, Month Begin Date, Month End Date, Month Name, Month Name ABBR, Month Name By Year Surf, Month Name Surf, Month Num Days, Month Num of Year, Quarter Begin Date, Quarter By Year Surf, Quarter End ABBR, Quarter End Date, Quarter Num of Year, Week Begin Date, Week End Date, Week Num of Year, Week of Quarter, Year ABBR, Year Begin Date, Year End Date, Year Num, Year Num Days. As used herein “Surf” may refer to a combination of two or more terms. For example, Day of Week Surf may combine a day number with the abbreviation, e.g., “1-Mon” for day 1, Monday. Month Name By Year Surf may combine a year with a month number and an abbreviation, e.g., “2018-01(Jan)” for Jan. 1, 2018. Month Name Surf may combine the month number with the month's name abbreviation, e.g., “01(Jan)” for January 1. Quarter by Year Surf may combine a year abbreviation with a quarter abbreviation, e.g., “18-Q1” for first quarter of 2018.

For example, Gregorian day 1 (e.g., 2019-01-01) may be described dimensionally as Date Full (Date)=“2019-01-01”, Day Num of Month=1, Day Num of Quarter=1, Day Num of Week=2, Day Num of Year=1, Day of Week ABBR=“Tue”, Day of Week Name=“Tuesday”, Day of Week Surf=“2-Tue”, Linear Day of Month=1, and so on. All remaining 364 days in the 2019 Gregorian non-leap year may be similarly described. Accordingly, a mapping is provided. For example, if one wishes to retrieve all Gregorian days belonging to a first fiscal quarter, then one could query the “Quarter Num of Year” for values equal to 1 and the result should be all Gregorian days found in the first fiscal quarter. Likewise, if one wishes to derive which quarter a Gregorian day belongs to, one would look up that Gregorian day's “Quarter Num of Year” value. Accordingly, a two-way transformation from the first calendar type to the second calendar type, or vice versa, may be provided.

The business calendar entity 402 may also include one or more period entities 406 (e.g., week, bi-week, month, year). Each period entity 406 may extend a schedule entry entity 408. The schedule entry entity 408 may include a start date time and an end date time. A schedule entity 410 may have one or more schedule entry entities 408, and may include a name and a time zone for the schedule entity 410. The business calendar entity 402 may in turn extend the schedule entity 410. Additionally the business calendar entity 402 may include one or more business calendar period types 412, which may include a level and a prefix. The business calendar period type entity 412 may extend an other schedule entity 414. The other schedule entity 414 may include a type, a schedule (e.g., schedule entity 410 identifier), and a child schedule (e.g., schedule entity 410 identifier). In one embodiment, each of the entities shown may be implemented as a relational database table.

As mentioned earlier, the calendaring API 302 may be used to provide for functionality to create, edit, and/or manage custom calendars 300. Some example API function include:

(1) getcalendarPeriods(calendar)—Returns fiscal types for a given calendar 300. If the calendar 300 is not passed as input it gets the fiscal calendar for the instance or domain.

(2) beginningOfThisSchedulePeriod(scheduleid,timezone,date)—Returns GlideDate based on scheduleid, timezone, and date inputs. The GlideDate returned may be representative of a start or beginning of a schedule period having the scheduleid identifier. The GlideDate may be an object, e.g., JavaScript object, which stores a date/time value such as “2018-01-30.”

(3) endOfThisSchedulePeriod(scheduleid,timezone,date)—Returns GlideDate representative of an end of the schedule period having the scheduleid identifier.

(4) beginningOfSchedulePeriodsAgo(units,scheduleid,timezone,date)—Returns GlideDate representative of the beginning of a desired unit (e.g., quarter) for the schedule period having the scheduleid identifier.

(5) endOfSchedulePeriodsAgo(units,scheduleid,timezone,date)—Returns GlideDate representative of the end of a desired unit (e.g., quarter) for the schedule period having the scheduleid identifier.

(6) beginningOfNextSchedulePeriod(scheduleid)—Returns GlideDate representative of the beginning of the next scheduled period after the schedule period having the scheduleid identifier.

(7) endOfNextSchedulePeriod(scheduleid)—Returns GlideDate representative of the end of the next scheduled period after the schedule period having the scheduleid identifier.

(8) getDateDim(GlideDate) returns GlideRecord of DateDimension—date defaults to sysdate if not passed as input.

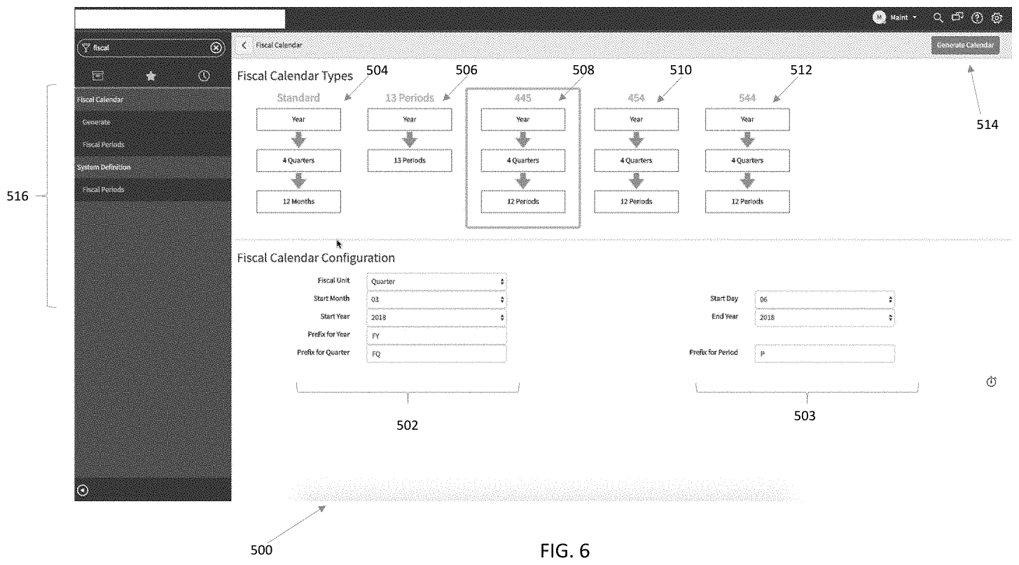

By using the above-describe example calendaring API, certain applications, such as calendar-based data entry 310, calendar-based data analysis 312, and/or calendar-based data management 314 may be focused on one or more specific calendar types. Accordingly, a user may work on one or more of the Gregorian calendar, fiscal calendars, academic calendars, manufacturing calendars, sales calendars, and/or farming calendars. It may be beneficial to illustrate certain of the applications as shown in FIG. 6.

FIG. 6 is a screenshot of an embodiment of a graphical user interface (GUI) 500 suitable for inputting certain calendar configuration information 502, 503 for various custom calendars 504, 506, 508, 510, and 512. The custom calendars 504, 506, 508, 510, and 512 are depicted as fiscal calendar types, but it is to be understood that any other calendar types may be generated and/or configured using the techniques described herein. In the depicted embodiment, the calendar 508 is selected. Accordingly, the configuration information 502, 503 depicted is for the calendar 508. The user may then enter a new configuration and proceed with generating, e.g., via button 514, the updated calendar 508.

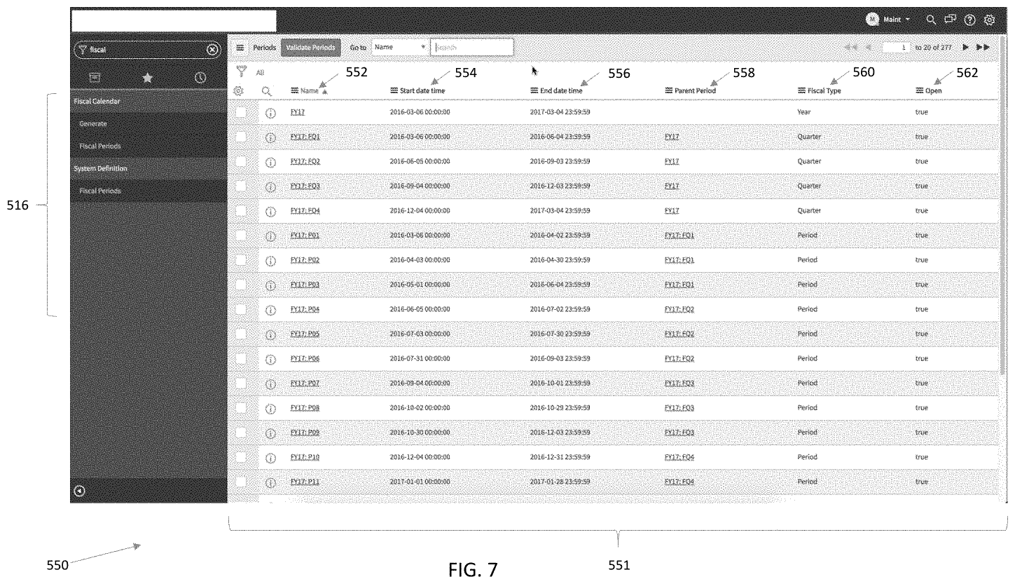

The calendars 504, 506, 508, 510, and 512 include calendars non-repeating and/or repeating periods such as years, quarters, months and weeks. For example, calendar 504 includes years, quarters and months only. Calendar 506 includes years and periods only. Calendars 508, 510, and 512 include years, quarters, and periods only. Menu section 516 may be used to navigate through the GUI 500. For example, by pressing the “Fiscal Periods” portion of the menu section 516, the user may execute a GUI shown in FIG. 7.

FIG. 7 is a screenshot illustrating an embodiment of a GUI 550 suitable for the retrieval of the various fiscal periods associated with a custom calendar, such as the calendar 508. More specifically, a GUI table section 551 illustrates various columns 552-562 containing fiscal period information related to the calendar 508. The data found in the GUI table section 551 may be retrieved by querying the tables used to implement the calendaring schema 304, for example, tables 306. That is, the calendaring schema 304 may be implemented as one or more tables, such as the tables 306. Calendar data may then be inserted into the tables 306 to define one or more custom calendars, such as the calendars 504, 506, 508, 510, and 512. In the depicted embodiment, column 552 includes the name for the fiscal periods, column 554 includes a start date time, column 556 includes an end date time, column 558 includes a parent period, column 560 includes a fiscal type (e.g., year, quarter, week, and so on), and column 562 includes information as to whether the period is still open or closed.

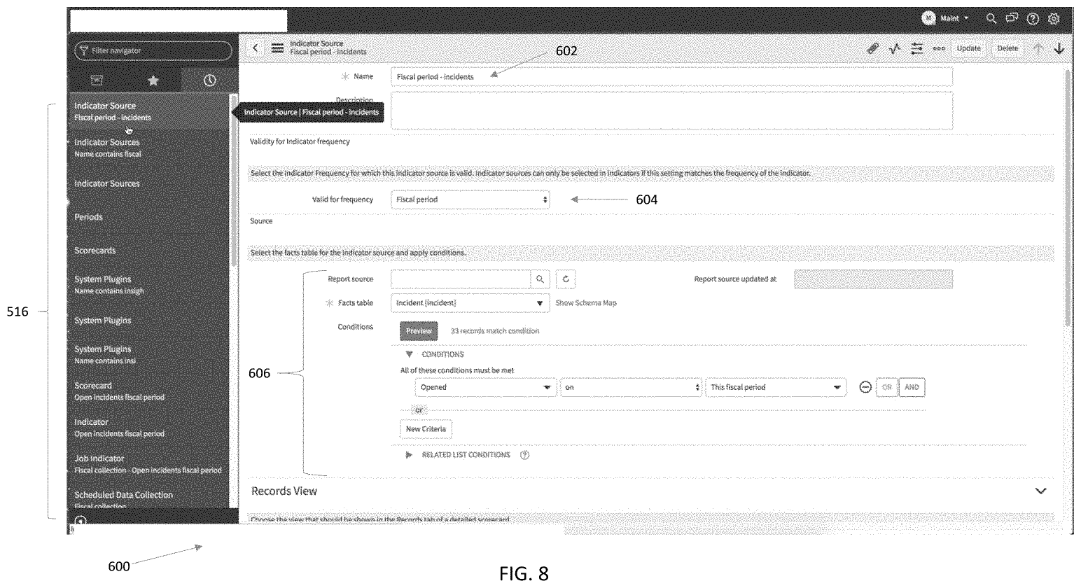

Calendar-based data may then be analyzed based on, for example, calendar attributes such as fiscal period. For example, FIG. 8 is a screenshot depicting an embodiment of a GUI 600 that may be used to select and then to analyze certain calendar-based data. In the depicted embodiment, certain incidents 602 may be analyzed. The incidents 602 may be analyzed to be valid for a given frequency of fiscal period 604 and to meet certain other characteristics 606, such as being an open incidents (as opposed to closed incidents).

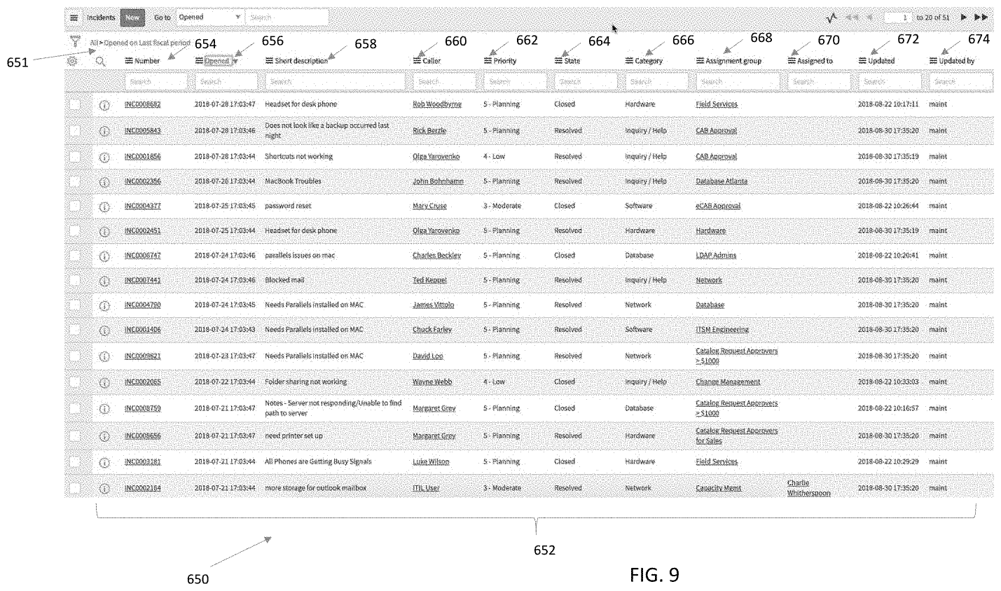

One or more queries may then be executed, for example, looking for open incidents (e.g., stored in a Gregorian calendar date time) that meet the desired characteristics 606. The resulting incidents may then be mapped, via the calendaring schema 304, so as to be presented in the desired custom calendar. For example, FIG. 9 is a screenshot illustrating an embodiment of a GUI 650 that is showing results from querying incident 602 records and mapping the results as belonging to the last fiscal period 651. More specifically, the figure illustrates a table section 652 having columns 654-674 with the various incident 602 records found that belong to the last fiscal period 651.

For example, an incident number is shown in column 654, a date of the opening of the incident is shown in column 656, a short description of the incident is shown in column 658, a caller reporting the incident is shown in column 660, a priority is shown in column 662, and incident state is shown in column 664, a category is shown in column 666, an assignment group is shown in column 668, an assigned to is shown in column 670, an updated is shown in column 672, and an updated by is shown in column 674. Accordingly, the GUI 650 may be used to analyze a number of metrics, such as which days incidents occur most frequently, fiscal period comparison between quarters, years, and other periods, type of incidents that are commonly reported, and so forth. By enabling the storing of data, e.g., incidents in a first calendar type, e.g., Gregorian type, but then mapping the data to a second (or more) type (e.g., fiscal type), the techniques described herein may provide for more efficient analysis that is customized to specific entities, such as schools, manufacturing facilities, farms, businesses of various types, and so on.

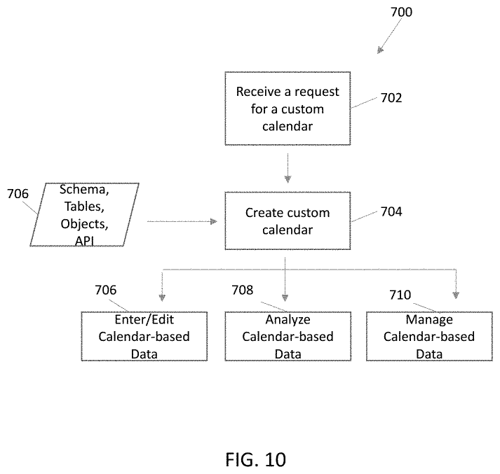

FIG. 10 is a flowchart of an embodiment of a process 700 that may be used to create custom calendars, such as the calendars 504-512, and then used to provide for data entry, data analysis and/or data management via the custom calendars, e.g. calendars 504-512. The process 700 may be implemented as computer instructions or code executable via the processor(s) 202 and stored in the memory 206. The process 700, for example, may be executed via the custom calendaring system 110. In the illustrated embodiment, the process 700 may receive a request (block 702) for a custom calendar. For example, a new academic calendar, a new fiscal calendar, a new farming calendar, a new business calendar, a new sales calendar, a new manufacturing calendar, and so forth, may be requested (block 702).

The process 700 may then create (block 704) the custom calendar, for example, by using certain items 796, such as the calendaring schema(s) 304, the calendaring tables 306, the calendaring API 302, and/or the calendaring objects 308. The custom calendars, e.g. calendars 504-512, may then be used by the process 700 to enter/edit (block 706) calendar-based data, to analyze (block 708) calendar-based data, and/or to manage (block 710) calendar-based data. For example, data may now be entered (block 706) in a custom calendar format (e.g., entering data for a given fiscal quarter, entering data for a school semester, entering data for a manufacturing run, entering data for a seed planting run, and so on). The data may then be analyzed (block 708) via custom calendaring analysis. For example, fiscal quarter results may be presented, school semester attendance may be shown, quality issues in the manufacturing run may be displayed, tons of seed planted during the seed planting run may be calculated, and so on. Likewise, the data may be managed (block 710) via custom calendaring to automatically generate schedules based on events in the server(s) 26, 104.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A computing system, comprising:
a server communicatively coupled to a data repository and configured to store a calendar-based data in the data repository, wherein the server is configured to perform operations comprising:
receiving a request to create a custom calendar;
creating the custom calendar based on a calendar data schema and the request;
providing the custom calendar to systems communicatively coupled to the server; and
providing a data analysis using the calendar-based data and the custom calendar.

2. The computing system of claim 1, wherein the calendar-based data is stored in a first calendar type different from a second calendar type of the custom calendar.

3. The computing system of claim 2, wherein the second calendar type comprises a Gregorian calendar type, an academic calendar type, a manufacturing calendar type, a fiscal calendar type, a farming calendar type, a business calendar type, or a combination thereof.

4. The computing system of claim 1, wherein creating the custom calendar comprises entering calendar information into one or more records of at least one database table representative of the calendar data schema, wherein the calendar information maps between a first calendar type of the calendar-based data into a second calendar type of the custom calendar different from the first calendar type.

5. The computing system of claim 4, wherein the calendar data schema comprises at least one date dimension table configured to store a calendar date in the first calendar type and one or more fields configured to store mapping information between the first calendar type and the second calendar type.

6. The computing system of claim 5, wherein the at least one date dimension table is configured to store only one day of the first calendar type per record.

7. The computing system of claim 6, wherein the first calendar type comprises a Gregorian calendar type and wherein the date dimension table is configured to store exactly 365 rows of days for a non-leap year.

8. The computing system of claim 5, wherein the mapping information comprises a list of columns including Day Num of Month, Day Num of Quarter, Day Num of Week, Day Num of Year, Day of Week Abbreviation (ABBR), Day of Week Name, Day of Week Surf, Linear Day of Month, Linear Week of Quarter, Linear Week of Quarter Begin Date, Linear Week of Quarter End Date, Month Begin Date, Month End Date, Month Name, Month Name ABBR, Month Name By Year Surf, Month Name Surf, Month Num Days, Month Num of Year, Quarter Begin Date, Quarter By Year Surf, Quarter End ABBR, Quarter End Date, Quarter Num of Year, Week Begin Date, Week End Date, Week Num of Year, Week of Quarter, Year ABBR, Year Begin Date, Year End Date, Year Num, Year Num Days, or a combination thereof.

9. The computing system of claim 1, wherein the server is configured to perform operations comprising:
receiving a second request to create a second custom calendar;
creating the second custom calendar based on the calendar data schema and the second request;
providing the second custom calendar to systems communicatively coupled to the server; and
providing a second data analysis using the calendar-based data and the second custom calendar, and wherein the data repository comprises a cloned data repository.

10. The computing system of claim 9, wherein the calendar-based data is stored in a first calendar type, the custom calendar comprises a second calendar type, the second custom calendar comprises a third calendar type, and wherein the first, second, and third calendar types are different from each other.

11. A method, comprising:
receiving, via a server communicatively coupled to a data repository and configured to store a calendar-based data in the data repository, a request to create a custom calendar;
creating, via the server, the custom calendar based on a calendar data schema and the request;
providing, via the server, the custom calendar to systems communicatively coupled to the server; and
providing, via the server, a data analysis using the calendar-based data and the custom calendar.

12. The method of claim 11, wherein creating the custom calendar comprises entering calendar information into one or more rows of at least one database table representative of the calendar data schema, wherein the calendar information maps between a first calendar type of the calendar-based data into a second calendar type of the custom calendar different from the first calendar type.

13. The method of claim 12, wherein the calendar data schema comprises at least one date dimension table configured to store a calendar date in the first calendar type and one or more columns configured to store mapping information between the first calendar type and the second calendar type.

14. The method of claim 11, comprising:
receiving, via the server, a second request to create a second custom calendar;
creating, via the server, the second custom calendar based on the calendar data schema and the second request;
providing, via the server, the second custom calendar to systems communicatively coupled to the server; and
providing, via the server, a second data analysis using the calendar-based data and the second custom calendar.

15. The method of claim 11, wherein the calendar-based data comprises a first calendar type comprising a Gregorian calendar type, an academic calendar type, a manufacturing calendar type, a fiscal calendar type, a farming calendar type, a business calendar type, or a combination thereof.

16. A non-transitory, computer-readable medium storing instructions executable by a processor of a computing system, the instructions configured to:
receive, via a server communicatively coupled to a data repository and configured to store a calendar-based data in the data repository, a request to create a custom calendar;
create, via the server, the custom calendar based on a calendar data schema and the request;
provide, via the server, the custom calendar to systems communicatively coupled to the server; and
provide, via the server, a data analysis using the calendar-based data and the custom calendar.

17. The computer-readable medium of claim 16, wherein the instructions configured to create the custom calendar comprise instructions configured to enter calendar information into one or more rows of at least one database table representative of the calendar data schema, wherein the calendar information maps between a first calendar type of the calendar-based data into a second calendar type of the custom calendar different from the first calendar type.

18. The computer-readable medium of claim 17, wherein the calendar data schema comprises at least one date dimension table configured to store a calendar date in the first calendar type and one or more columns configured to store mapping information between the first calendar type and the second calendar type.

19. The computer-readable medium of claim 16, wherein the instructions are configured to:
receive, via the server, a second request to create a second custom calendar;
create, via the server, the second custom calendar based on the calendar data schema and the second request;
provide, via the server, the second custom calendar to systems communicatively coupled to the server; and
provide, via the server, a second data analysis using the calendar-based data and the second custom calendar.

20. The computer-readable medium of claim 16, wherein the calendar-based data comprises a first calendar type comprising a Gregorian calendar type, an academic calendar type, a manufacturing calendar type, a fiscal calendar type, a farming calendar type, a business calendar type, or a combination thereof.
